(19) United States
(12) Patent Application Publication
(10) Pub. No.: US 2015/0148943 A1
(43) Pub. Date: May 28, 2015

(54) PROGRAMMABLE TIME MOTORIZED TAMPERPROOF BLISTER PACK DOSAGE DISPENSER AND METHOD OF PREVENTING UNAUTHORIZED USE OF PHARMACEUTICALS AND OTHER ITEMS

(71) Applicant: John Timothy Sullivan, Marriottsville, MD (US)

(72) Inventor: John Timothy Sullivan, Marriottsville, MD (US)

(21) Appl. No.: 14/090,138

(22) Filed: Nov. 26, 2013

(51) Int. Cl. A61J 7/00

(52) U.S. Cl. CPC A61J 7/0076
USPC 700/231

(57) ABSTRACT

A dispensing device for dispensing medications or other items required to be dispensed according to a predetermined schedule includes a mechanism for advancing a bandolier containing the medications or other items to a dispensing position only when activated by an authorized user at predetermined time intervals. Access to the bandolier is limited at all other times to personnel in a controlled facility. The dispensing device may be utilized to implement a method of controlling access to addictive prescription medications.

### BACKGROUND OF THE INVENTION

1. Field of the Invention

The invention relates to a dispensing device for dispensing medications or other access-controlled items, and to a method that uses the dispensing device for controlling dispensation of medications and other access-controlled items.

The invention also relates to a dispensing device and method of using the dispensing device for preventing intentional abuse or misuse of hazardous or addictive prescription medications, such as opiate-based pain killers classified according to U.S. Drug Enforcement Administration (DEA) “Schedule 2” and that are self-administered by users in pill, tablet, or capsule form. The invention may also be applied to Schedule 1 substances prohibited under U.S. federal law but permitted under state or foreign law, as well as other hazardous or addictive substances not currently prohibited or classified under DEA schedules.

The dispensing device of the invention may also be used to dispense prescription medications that do not present a risk of intentional abuse or misuse, or non-prescription medications, as well as non-medical items to which access is required to be limited based on a predetermined schedule. In the case of medications that do not present a risk of abuse, the dispensing device of the invention may be used to facilitate medications by those who have difficulty with conventional packaging, to prevent dosage errors by those who have difficulty keeping track of dosages and schedules, and/or to ensure proper disposal of unused medications.

The method of the invention provides for loading of the dispensing device in a secure facility, distribution of the device to patients or users directly through mail order from the secure facility or through independent distributors such as pharmacies, identification and authentication of users before doses or items are dispensed, monitoring of usage and tracking of the dispensing device, and securing or disposal of unused medications or other items upon return of the dispensing device.

The dispensing device is constructed to be locked and tamper proof, and the method of the invention provides for external monitoring or tracking of the dispensing device as well as automatic or selective timed dispensing of individual doses or items to a patient or user over a pre-programmed length of time without the patient or user having any access to the remainder of the doses or items housed within individual blister pack compartments locked within the dispenser.

2. Description of Related Art

Although applicable to items other than medications or prescription drugs, the invention was designed to address problems related to prescription drug abuse or misuse, whether intentional or accidental, and in particular the misuse of addictive prescription drugs such as opiate-based pain killers that are currently packaged in pill, tablet, or capsule form. The invention was inspired by the tragic death of the inventor's young son by overdose of prescription opiates, and one objective of the present invention is to enable that young man's needless death serve as a catalyst for good in preventing other such needless deaths.

While the invention includes features that prevent access to addictive controlled medications, the invention also may be used to prevent unintentional dosage errors by, for example, the elderly and those with impaired memory who might have difficulty opening conventional packaging and keeping track of dosages and schedules, as well as to provide a way to ensure proper disposal of unused medications after they are no longer needed or upon expiration of a valid prescription.

A solution to the problem of prescription medication abuse, addiction, overdoses, and deaths involving non-medical prescription drug use, especially narcotic pain relievers, is desperately needed. A recent study estimated that in 2006 the total cost in the United States of nonmedical use of prescription opioids was $53.4 billion, attributable to lost productivity, criminal justice costs, drug abuse treatment, and medical complications. Attempts to solve this problem by monitoring prescriptions and prosecuting drug traffickers and clinicians who write fraudulent prescriptions has not prevented the rapid increase in prescription medication abuse, and especially the large increase in abuse by teenagers and young adults who might be introduced to the drugs through legitimate prescriptions of family members or friends.

Most technology-based solutions to problems relating to dosage control have focused on the problem of access to the medications, and of ensuring that a medication schedule is followed. These systems include electronic reminder systems such as the one disclosed in U.S. Pat. No. 6,198,383, and mechanical devices that dispense one dose at a time, such as the device disclosed in U.S. Pat. No. 3,407,962, which includes a dial that is turned by the user to dispense a single dose, and that includes markings of the days of the week. However, while such systems and devices are helpful if the user is willing and able to utilize them, electronic reminder systems can be ignored or misunderstood, and mechanical devices may be difficult to use and cannot ensure that doses are not skipped or dispensed too often. In addition, many such mechanical devices require a relatively high degree of dexterity. Furthermore, such devices do not address the problem of intentional prescription drug abuse.

A more comprehensive dosage control solution, which seeks to limit access to medications according to a predetermined dosage schedule, has been proposed in U.S. Pat. No. 7,537,005. U.S. Pat. No. 7,537,005 discloses a dispensing unit adapted to receive a sealed container and that causes a measured dose of medication to be dispensed from the container upon release of a remotely-controlled locking mechanism that provides for user authentication and possibly physician input before allowing the medications to be dispensed. However, the dispensing device disclosed in this patent is arranged to be configured by the patient, using a cartridge that contains configuration instructions, and the sealed containers are also provided separately to the patient for installation. Because the patient has access to the dispensing mechanism, the dispensing mechanism can be tampered with, or the container itself may be broken-into before installation in the dispensing device. Further, there is no provision to ensure proper disposal of unused medications, or of medications left over after expiration of the prescription

Another access-controlled medication dispensing device is disclosed in U.S. Patent Publication 2007/0186923. This publication also discloses a dispensing device that requires user authentication before dispensing doses, and further provides for usage monitoring, RFID and GPS tracking, and other security features. However, the dispensing device itself uses a push-out dispensing mechanism (similar to a Pez dispenser) that is vulnerable to attempts to defeat the locking mechanism and forced extraction of medications, and furthermore utilizes medication-containing cartridges or strips that are loaded by the user, thereby enabling access by the user to both the dispensing mechanism and the cartridges or strips that contain the medications. As a result, the device and method disclosed in U.S. Patent Publication 2007/0186923 has not solved the problem of prescription medication abuse, which continues to exact high economic and social costs, and many needless deaths.

### SUMMARY OF THE INVENTION

It is accordingly an objective of the invention to provide a dispensing device, and a method of utilizing the dispensing device, that addresses the problem of prescription medication abuse and that will prevent needless deaths from overdose.

In meeting this objective, however, the invention also provides a device and method that is generally applicable to schedules dispensing of a medications and other items other than prescription drugs subject to abuse.

According to one aspect of the invention, a dispensing device is arranged to be loaded with at least one removable bandolier, either contained in a cartridge or directly loaded into a mounting receptacle in the device. A carefully counted number of dosage units are sealed within moisture impervious shells, containers, or blisters that are carried on a flexible, segmented strip so as to provide the user with a fresh supply of dosage units to last for a predetermined time interval each time the strip is advanced to a dispensing position. In a variation of the sealed shells, containers, or blisters, manually-fillable containers may be provided.

According to preferred embodiments of the invention, the dispensing device includes a mechanical linkage by which to advance the bandolier from the supply cylinder or spool along a feeding track to the dispensing position at which the dosage units may be removed from the shells, containers, or blisters. The dispensing position of the strip may be within the dispensing device, in which case the dosage units are removed by a deblister mechanism that pushes the dosage units from individual shells, containers, or blisters and sends them along a tortuous or zigzag path or chute to a dispensing opening. Alternatively, a section of the strip that contains the dose to be dispensed may be advanced to a dispensing position outside the dispensing device, at which position the section can be manually separated from the bandolier or strip by tearing along a transversely perforated line.

According to preferred embodiments of the invention, the bandolier or strip is advanced by a stepper motor. Alternatively, according to other preferred embodiments of the invention, to reduce power consumption and extend battery life, advancement of the bandolier or strip may be achieved by a mechanical actuator such as a lever or knob connected to an advancement gear set by a ratchet mechanism and a solenoid or motor-controlled clutch mechanism that prevents advancement when no power is supplied to the solenoid or clutch driving motor. In either case, measures may be provided to prevent the strip from being forcibly pulled from the dispensing device, the measures including provision of a worm gear in the advancement mechanism, and/or including of a spring loaded locking mechanism for preventing movement of a ratchet wheel when the ratchet wheel is disengaged from a manual actuator.

The dispensing device further includes electronic means to prevent misuse, such as having the controller require biometric or passcode identification before permitting a dose to be dispensed, as well as radio frequency identification (RFID) and GPS or other tracking capabilities that permit the dispensing device to be tracked so that it can be located if the dispensing device is not properly returned to the provider. According to an especially advantageous feature of the invention, the dispensing device may include sensing capabilities for determining the blood oxygen level of the patient, or other symptoms or markers, in order to prevent dispensation of drugs in case of an overdose.

While the dispensing device may be used for dosage control in environments where further controls are not needed, such as to dispense medications other than those with a potential for abuse, or other items, the dispensing device is especially suitable for use in connection with the method of the invention, which provides for use of the dispensing device to prevent prescription abuse or misuse. According to the method of the invention, the dispensing device is loaded with medications and configured with contents identification information in a secure facility, for example a facility operated by the U.S. DEA, and then locked before leaving the facility. For maximum security, the dispensing device may also be configured with patient information, including patient identification and dosage information, at the secure facility and then shipped directly to the patient, although it is also within the scope of the invention for the dispensing device to be initially shipped to a pharmacy and patient information entered at the pharmacy upon presentation of a verified prescription. Once in the possession of the patient, the dispensing device is controlled to enable dispensing of medications at programmed intervals, until the medication is used up or the prescription expired, at which time the patient is required to return the dispensing device to the same or another secure facility. If the dispensing device is not returned, measures are taken to locate the dispensing device, for example by GPS-based tracking, the patient may forfeit a deposit, and appropriate parties such as law enforcement and/or the patient's physician are notified. In addition, alerts may be transmitted if tampering or attempts at unauthorized dispensation of medications are detected.

### BRIEF DESCRIPTION OF THE DRAWINGS

FIG. 1 is an isometric views of a blister pack for use in a programmable prescription time capsule in accordance with the principles of a preferred embodiment of the invention.

FIGS. 2-5 are isometric views showing an alternative blister pack capable of being manually loaded.

FIG. 6 is an isometric view showing a cartridge for use in a dispensing device according to a first preferred embodiment of the invention.

FIG. 7 is an isometric view of a stepper motor driven bandolier or strip advancing mechanism and a deblister mechanism according to a second preferred embodiment of the invention.

FIG. 8 is an isometric view showing a variation of the bandolier or strip advancing mechanism of FIG. 7.

FIG. 9 is an isometric view of a stepper motor driven bandolier or strip advancing mechanism according to a third preferred embodiment of the invention.

FIGS. 10 and 11 are isometric views showing a variation of the bandolier or strip driving mechanism of FIG. 9.

FIGS. 12-14 are isometric views of a solenoid-controlled slide-actuated bandolier or strip advancing mechanism according to a fourth preferred embodiment of the invention.

FIGS. 15 and 16 are isometric views of a solenoid-controlled, knob-actuated bandolier or strip advancing mechanism according to a fifth preferred embodiment of the invention.

FIG. 17 is an isometric view of a variation of the bandolier or strip advancing mechanism of FIGS. 15 and 16, with an additional spring-loaded advancement lock.

FIGS. 18-21 are isometric views of a dispensing device that includes the advancing mechanism of FIGS. 15 and 16.

FIGS. 22 and 23 are isometric views showing another embodiment of a manually-actuated bandolier or strip advancing mechanism, in which the clutch mechanism is operated by a thread driver mechanism and a motor.

FIG. 24 is a is a flow chart of a method of preventing prescription medication misuse that utilizes the programmable dispensing device of FIGS. 1-23, according to a preferred embodiment of the invention.

### DETAILED DESCRIPTION OF THE PREFERRED EMBODIMENTS

Throughout the following description and drawings, like reference numbers/characters refer to like elements. It should be understood that, although specific exemplary embodiments are discussed herein there is no intent to limit the scope of present invention to such embodiments. To the contrary, it should be understood that the exemplary embodiments discussed herein are for illustrative purposes, and that modified and alternative embodiments may be implemented without departing from the scope of the present invention. For example, although the items dispensed by the illustrated dispensing device are illustrated as pills, tablets, or capsules, the bandolier containing the items may be adapted to dispense items, including non-medical items, other than pills or capsules.

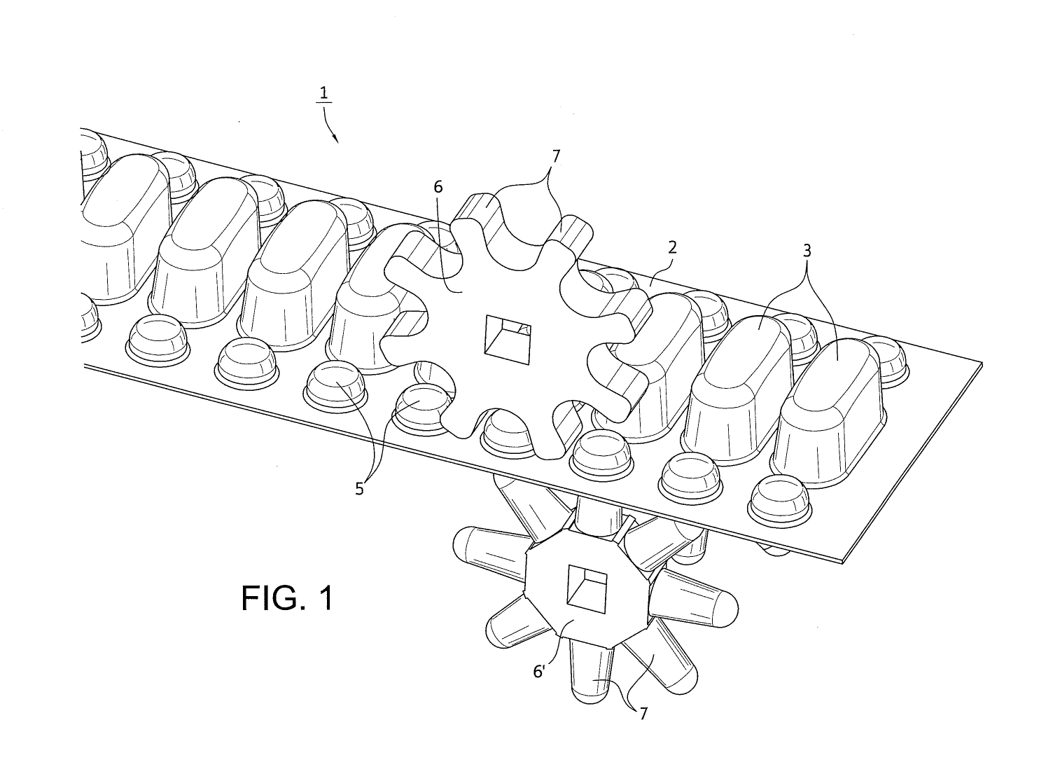

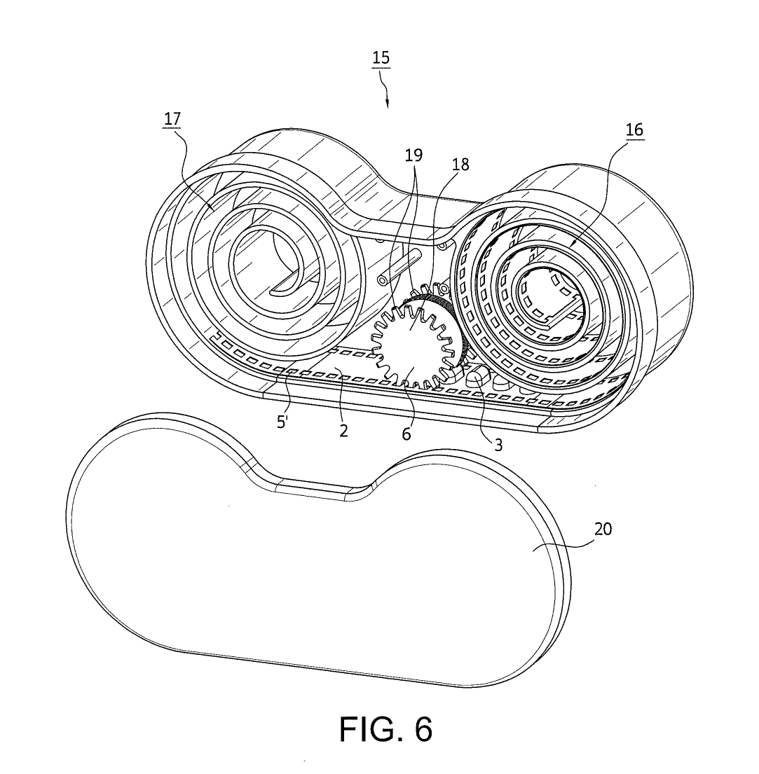

FIG. 1 shows a bandolier or blister pack 1 for use in dispensing devices constructed in accordance with the principles of preferred embodiments of the invention. The bandolier 1 is made up of a plastic strip 2 and individual pockets or holders 3 for holding individual doses in the form of pills, tablets, or capsules 4, an example of which shown in FIG. 6 for illustrative purposes as being separate from the bandolier 1. The holders 3 may be conventional clear plastic blisters insert-molded into the strip 2, or may consist of bubbles formed during molding of the strip. The strip 2 also includes indentations or detents 5 extending longitudinally along one or both sides of the strip, as shown in FIG. 1, or perforations 5′ on one or both sides of the strip as shown in FIG. 6. The size and spacing of the perforations 5 or indentations 5′ depends on configuration of a sprocket wheel 6 on top of the strip or a sprocket wheel 6′ on the bottom of the strip, sprocket wheel 6 or 6′ being used to advance the strip 2 and on the size of the individual doses 4 to contained in the blister pack 1, arms or spokes 7 of the sprocket wheel 6 or 6′ being arranged to fit within or between the indentations or detents 5, or perforations 5′, to advance the strip 2 by as it is rotated. If the holders 3 are blisters, then each blister may be closed with a layer of foil or a thin plastic section that is punctured as the pressure is applied to the opposite surface of the blister or bubble so that the pill, tablet, or capsule passes through the foil layer or thin plastic section and is released into a dispensing channel.

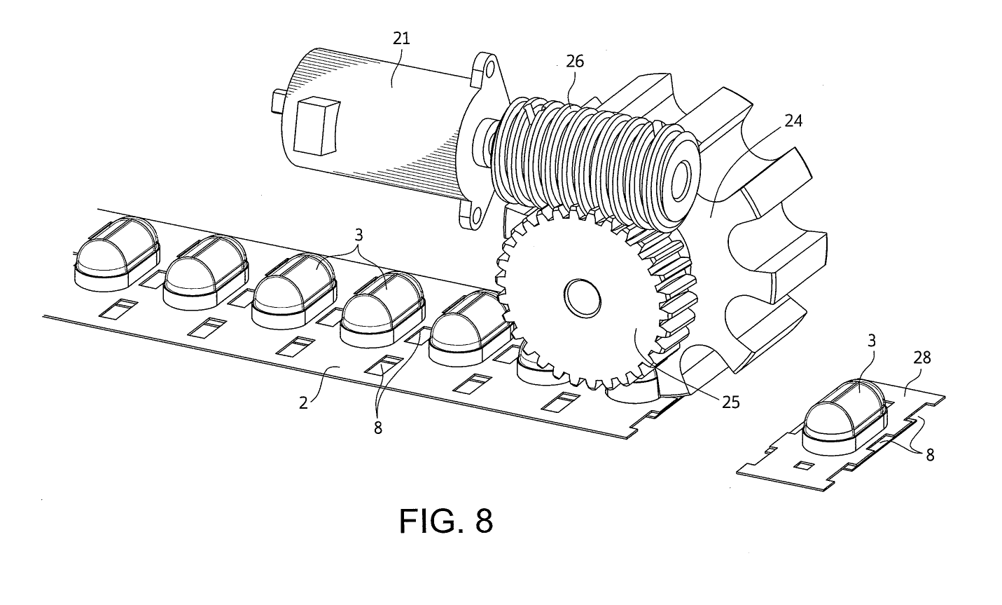

As shown for example in FIGS. 8-17, the indentations or detents 5, or the perforations 5′, may be omitted and the strip may be driven by a sprocket wheel that directly engages the dose holders 3. In addition, as also shown in FIGS. 8-13, the strip 2 may include transverse perforations 8 that permit a section of the strip to be manually torn away from the strip in order to remove a single one of the individual dose-containing holders 3 when the strip 2 is advanced outside the dispensing device.

Each plastic strip 2 is preferably embedded with externally readable markers, such as radio frequency identification data (RFID) strips (not shown). These non-erasable strips can be easily and inconspicuously attached anywhere along the width of the strip, and extend along its entire length. The RFID strips are embedded with data regarding the medication being dispensed, as well as identifying data about the dispensing device.

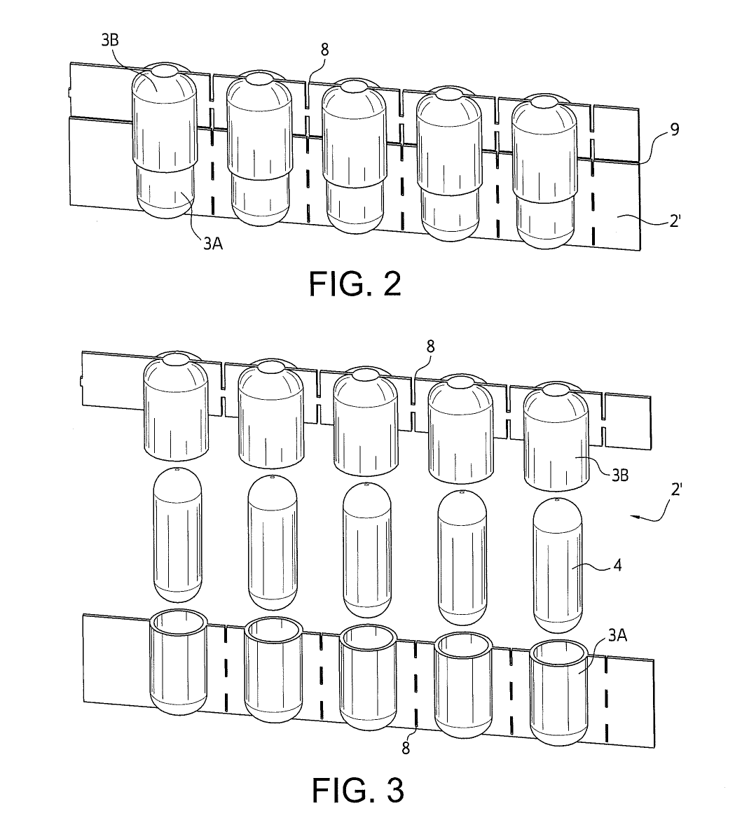

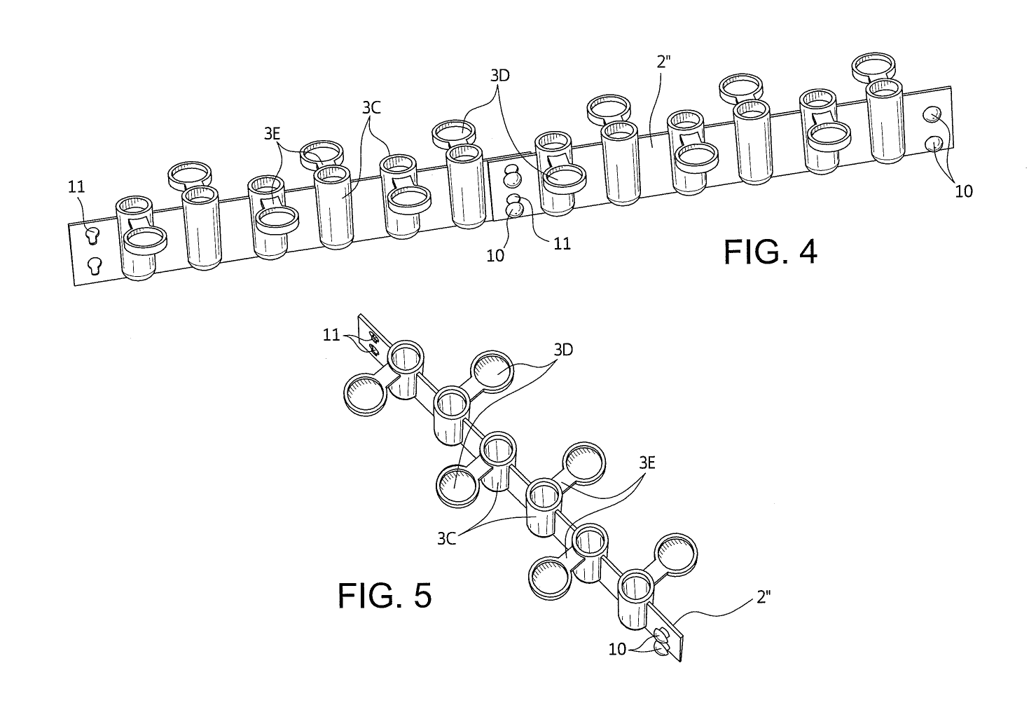

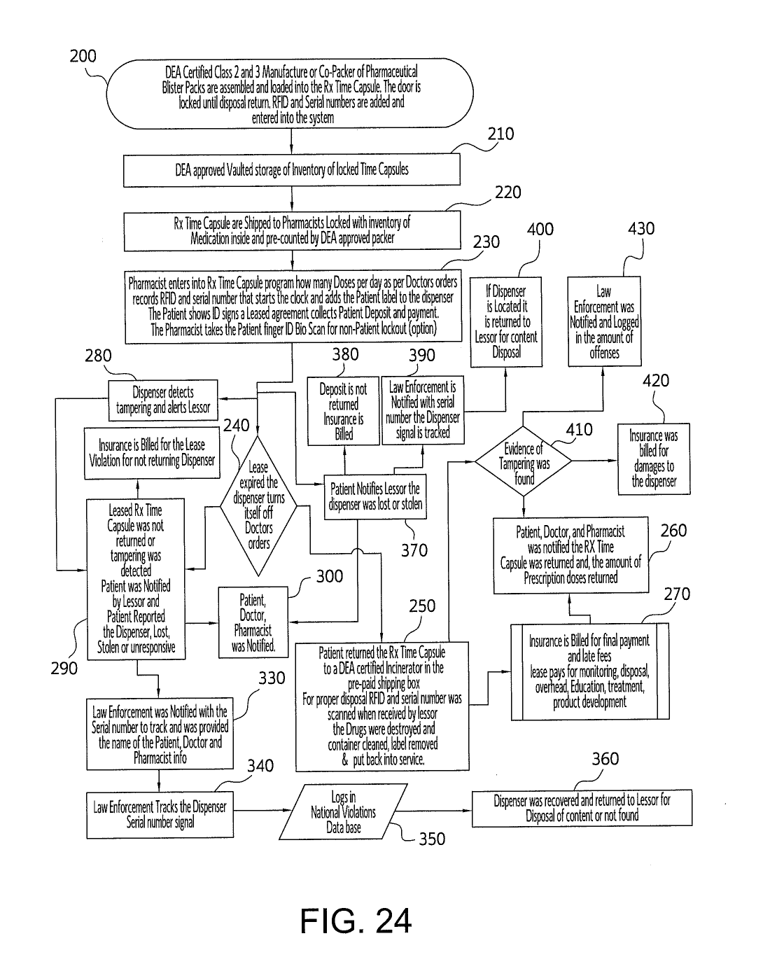

FIGS. 2 and 3 show a variation of the bandoliers illustrated in FIGS. 1 and 6-17, in which a strip 2′ is further split along its length and a longitudinal seam 9, and the bubbles or blisters 3 shown in FIG. 1 are replaced by interfitting cylindrical container halves 3A and 3B arranged to enclose or capture individual pills, tablets, or capsules 4 when fitted together. FIGS. 4 and 5 show a further variation in which the strip 2″ is molded with cylindrical holders 3C and lids or caps 3D separated from the holders 3C by strips 3E. While the strip 2′ of FIGS. 2 and 3 includes transverse perforations 8 to enable sections to be torn away while opposite ends of the strip 2″ of FIGS. 4 and 5 include pegs 10 and locking apertures 11 to enable multiple strips to be fastened together, it will be understood that the perforations 8 may be included in strip 2″ and omitted from strip 2′, and that the peg-and-aperture strip connecting arrangement of FIGS. 4 and 5 may be omitted from strip 2″ or optionally added to strip 2 of FIG. 1 or strip 2′ of FIGS. 2 and 3. The split or capped holder variations shown in FIGS. 2-5 enable a drug compounder or pharmacist to hand load individual pills or tablets into the holders before placing the strips 2′ or 2″ in the dispensing device. It will be understood, however, that hand-loading of individual tablets or pills outside a secure facility is not permitted when the dispensing device is used in the method of FIG. 24 to control dispensing of prescription medications that are subject to abuse, in which case loading and access to the contents of the dispensing device is permitted only in a secure facility.

FIG. 6 shows an arrangement in which the bandolier, illustrated as including strip 2 having longitudinal sprocket-engaging perforations 5′ and holders 3 in the form of blisters or bubbles, is enclosed within a cartridge 15 before being placed in the dispensing device. The strip 2 unrolls from a first coiled track or spiral passage 16 on one side of the cartridge 15 into an initially-empty coiled track or spiral passage 17 on the other side of the cartridge in response to rotation of sprocket wheel 6 driven by a shaft that extends into the cartridge when mounted in the dispensing device and a stepper motor coupled to the shaft (the shaft and stepper motor are not shown in FIG. 6). Also coupled to the shaft is a deblister wheel 18 having arms 19 that engage the blisters or bubbles as the deblister wheel rotates in order to push individual doses out of the blisters or bubbles and through an opening in the cartridge that leads to an exit passage in the dispensing device. The cartridge 15 is closed by a lid 20.

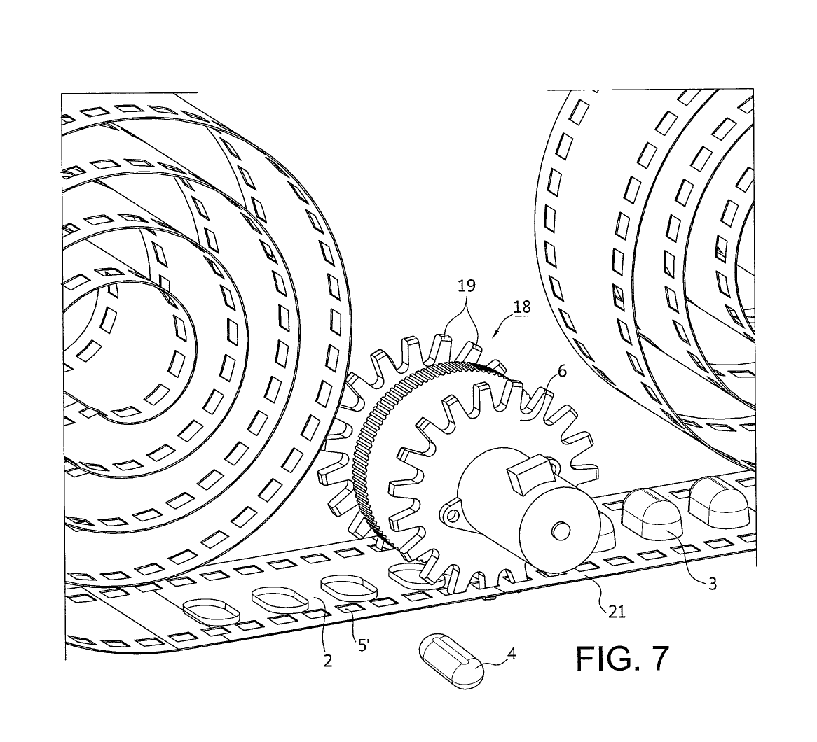

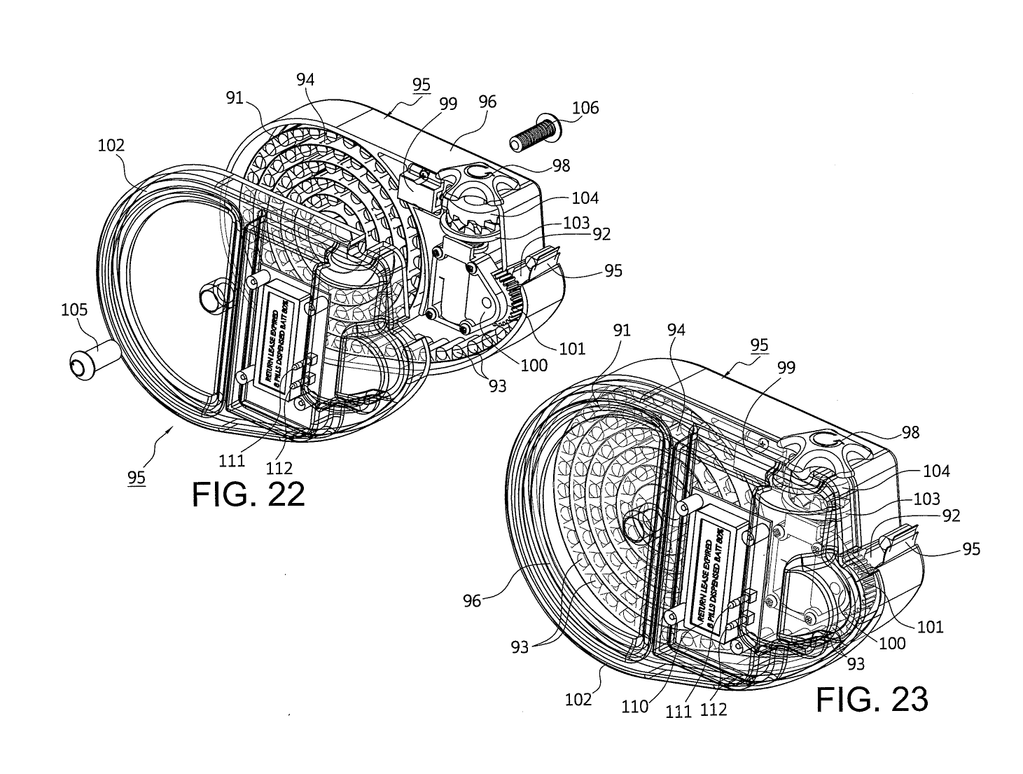

It will be appreciated by those skilled in the art that, rather than placing the bandolier in a cartridge, the spiral passages 16 and 17 may be provided in a compartment of the dispensing device itself, and the sprocket and deblister wheels also mounted directly in the dispending device. The advancing mechanism illustrated in FIG. 7 may also be used with the cartridge 15 of FIG. 6 or directly in the dispensing device, while the advancing mechanisms of FIGS. 7-23 are generally applied directly in the dispensing devices.

FIG. 7 shows essentially the same bandolier or strip advancing arrangement as illustrated in FIG. 6, but which is not required to be placed in a cartridge, and in which motor 21 is illustrated. The motor 21 advances the strip 2 by a predetermined distance corresponding to the dispensing of a single dose, represented by the illustrated pill, tablet, or capsule 4. A timer prevents advance of the motor 21 until a predetermined interval has elapsed after the last dispensation, after which the motor 21 may be caused to advance the strip by one dose when the user presses a dispensing button or the like (not shown). The sprocket wheel 6 and deblister wheel 18 may be directly driven by the motor, or indirectly driven through additional gears or other transmission components. Once a dose has been pushed out of the holder 3 by the deblister wheel, it preferably exits the dispensing device via a chute or passage having multiple turns that limit access to the strip from outside the dispensing device.

The motor 21 is preferably a stepper motor, such as a brushless DC electric stepper motor, which divides the rotation into a number of equal steps, enabling the precise advance of the strip 2 by a predetermined distance corresponding to one or more of the individual doses. The stepper motor's position can be commanded to move and hold at one of the steps, allowing for dispensing of exactly the prescribed number of pills at one time. Motors other than stepper motors may carry out the same advance and hold function if properly controlled, but a stepper motor is preferred because it can be controlled to hold a fixed position against an external torque, thereby holding the strip at the last dispensing position until advancement is permitted and preventing the strip from being forcibly advanced to enable a user to access doses at other than the pre-programmed interval.

In the embodiment shown in FIG. 8, the sprocket wheel 24 directly engages the blisters or bubbles 3 to advance a dose to a dispensing position. Furthermore, the deblister wheel of FIG. 7 is eliminated and the strip 2 is instead advanced out of the dispensing device by a predetermined distance sufficient to enable the patient to grasp an individual section 28 of the strip 2 containing one dose, the individual section 28 at the end of the strip 2 being removable from the remainder of the strip by tearing the individual section at the transversely extending perforations 8. Once the individual pill-containing section of the strip has been torn off by the patient, the contents of the bubble or blister can be manually removed by the patient in conventional fashion by pushing on the blister to cause the pill to break through the foil or plastic at the base of the blister, by removing an adhesively secured foil or plastic cover, or by any other conventional method of removing one or more pills from a section of a blister pack or other dose-containing bandolier or strip.

In this embodiment, the user is prevented from pulling on the end of the strip 2 in order to forcibly advance the strip to a next dose before the predetermined dosage interval has elapsed. This is accomplished by driving the sprocket wheel 24 through a gear train that includes a sprocket wheel drive gear 25 and a worm gear 26 that acts as a brake by increasing the torque necessary to force the motor 21 to rotate in response to pulling on the strip.

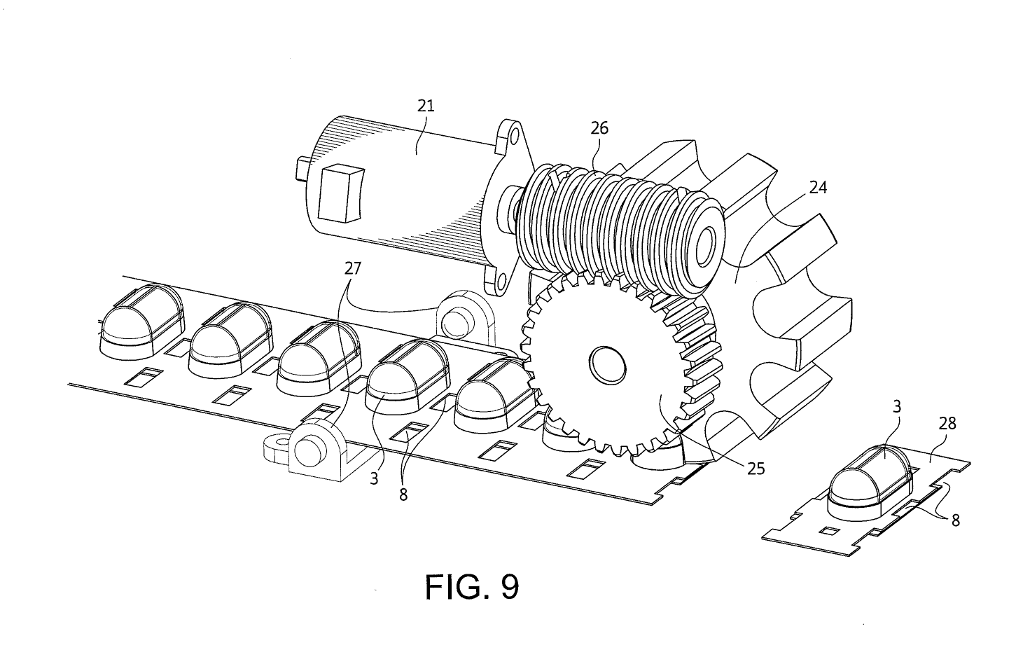

In the variation shown in FIG. 9, an optical or mechanical sensor unit 27 may be provided to monitor advance of the strip by counting the passing blisters or bubbles 3, in order to provide feedback to the motor controller, to track the number of doses dispensed, and/or to provide usage data that can be used to detect tampering or unauthorized usage. The sensor unit may alternatively be arranged to detect perforations or indentations in the strip, markings on the strip or holders, movement of an advancing gear, or other indications of strip movement.

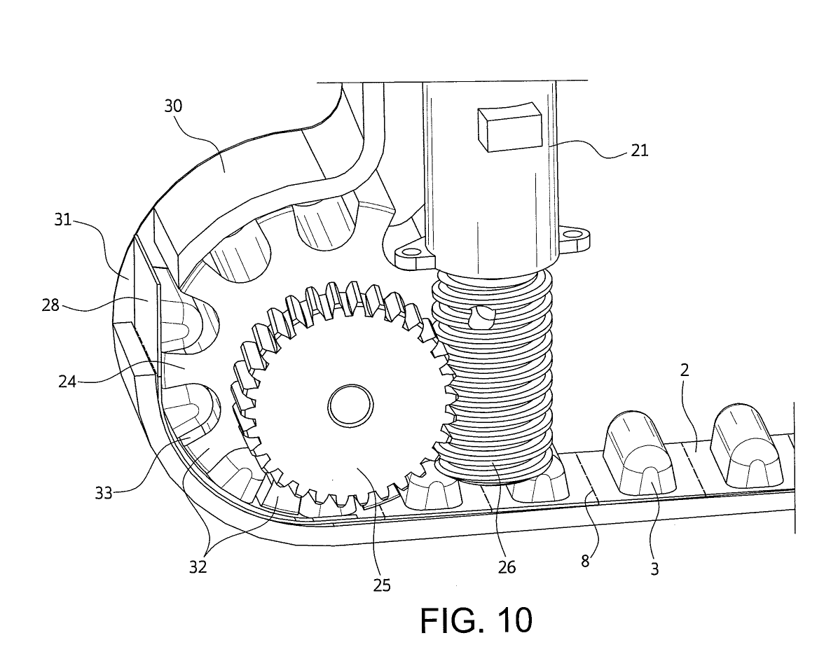

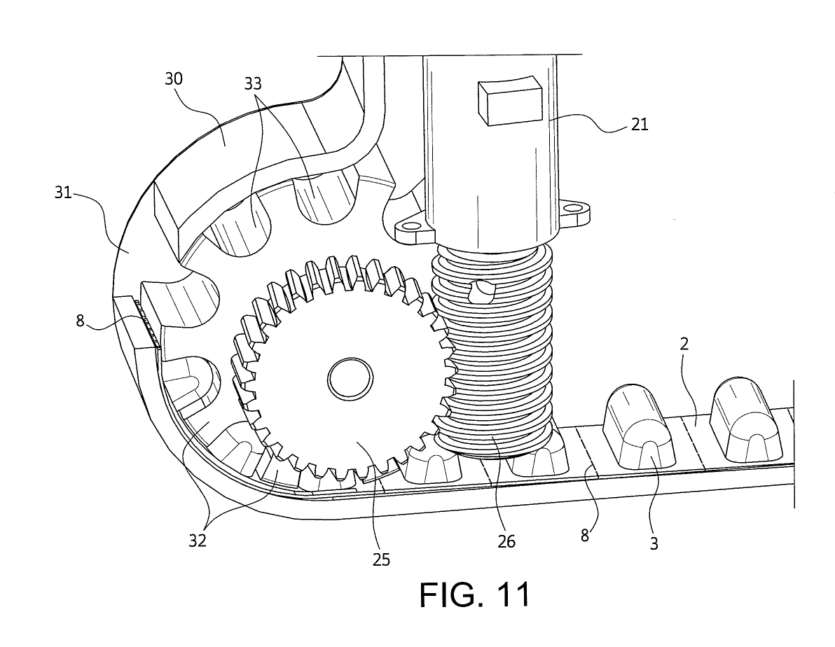

FIGS. 10 and 11 illustrate the manner in which the advancing mechanism of FIG. 8 may be installed in a dispensing device having a housing 30 and an exit opening 31 through which single-dose sections of the strip are advanced by the advancement mechanism according to the pre-programmed dosage schedule. The advancement mechanism includes sprocket wheel 24, drive gear 25, worm gear 26, and stepper motor 21. Housing 30 has a radius that matches that of sprocket wheel 24 such that the ends of the sprockets 32 of sprocket wheel 24 are adjacent the housing 30 and essentially close the openings 33 between the sprockets to prevent access to the holders until they exit the dispensing device. By shaping the openings 33 to wrap around the holders 3, the sprockets provide a greater surface area to help prevent the strip 2 from being pulled out of the dispensing device. FIG. 10 shows a strip section 28 that has advanced into the opening to a dispensing position at which it can be removed from the dispensing device as shown in FIG. 11.

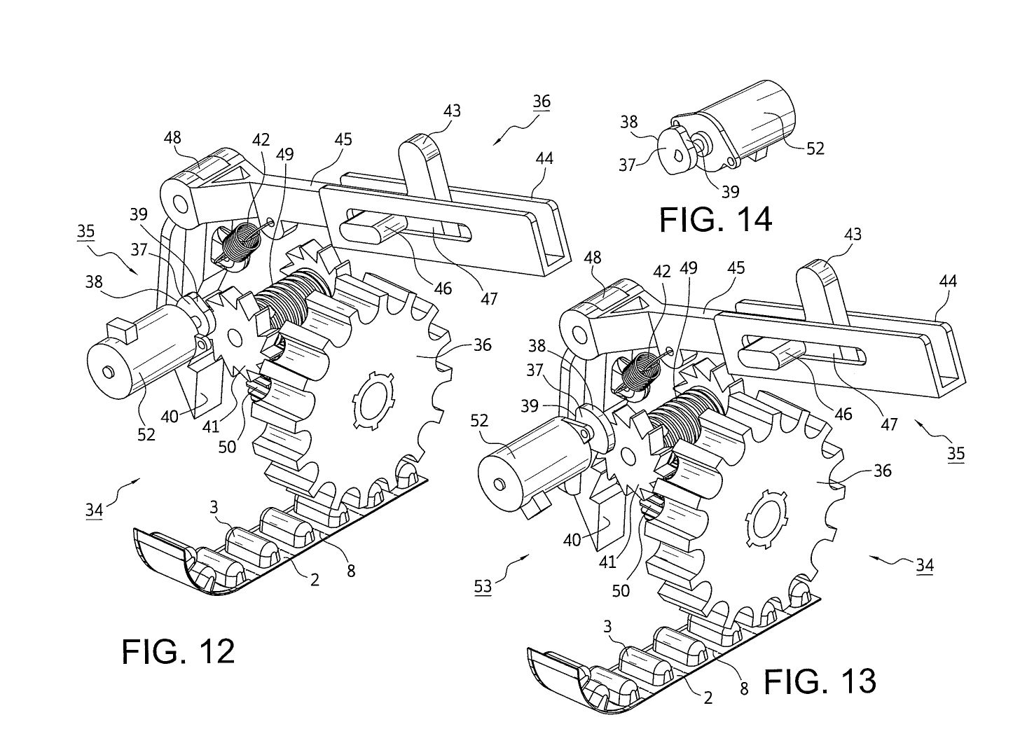

In order to reduce power consumption, and therefore prolong battery life when the dispensing device is powered by batteries, the stepper motor may be replaced by a manual actuator and solenoid operated clutch arrangement, variations of which are illustrated in FIGS. 12-17.

FIGS. 12-14 show a first variation of the manual actuator and clutch arrangement, in which the strip advancing mechanism 34, in which the stepper motor is replaced by a solenoid-operated clutch mechanism 53 and manual actuator 35. The manual actuator 35 drives a sprocket wheel 36 that advances the strip 2 by engaging individual blisters or bubbles 3. Each time the solenoid 52 is activated, a cam 37 rotates one from a rounded side 38 to a flat side 39, which permits a ratchet claw 40 to engage a ratchet gear 41 under the force of a tension spring 42. The manual actuator 35 includes a handle 43 slidable in a guide 44, an arm 45 extending from the handle 43, n slide arm 46 slidable in a slot 47 of guide 44 to limit movement of the handle 43, and a pivot 48 at a distal end of the arm 45 for pivotally supporting the ratchet claw 40. When the ratchet claw 40 is engaged with the ratchet gear 41, then sliding of handle 43 will cause the engaged ratchet claw 40 to advance the ratchet gear 41 by one tooth, and thereby advance the sprocket wheel 36 and strip 2 by a distance sufficient to advance one dose into the dispensing position. On the other hand, when power to the solenoid 52 is cut-off, the cam 37 rotates to and remains in a position that presents the curved face 39 of the cam 37 to the ratchet claw 40, causing the ratchet claw to be moved away from the ratchet gear against the force of tension spring 42. Because the ratchet claw 40 cannot engage the ratchet gear 41 in this position, movement of the handle 43 is not transmitted to the ratchet gear 41, and advancement of the strip 2 by movement of the handle 43 is not possible.

Preferably, in this embodiment, the ratchet gear 41 drives the sprocket wheel 36 through a worm gear 49 and drive gear 50 so as to increase the amount of torque necessary to rotate the wheel in a reverse direction and therefore resist manual advancement of the strip 2 by pulling on the strip from outside the dispensing device. The advancement mechanism of this embodiment has an advantage that the cam 37 will stay in position even when the power is cut off so as not to drain the battery. If desired, the controller can be set to position the cam 37 to the flat side 39 to enable dispensing of medications when the battery voltage is low. In addition, the use of a manually-driven advance further reduces the load on the battery since the solenoid 52 is not used to advance the strip 2, but only as a clutch to engage or disengage the advancing mechanism.

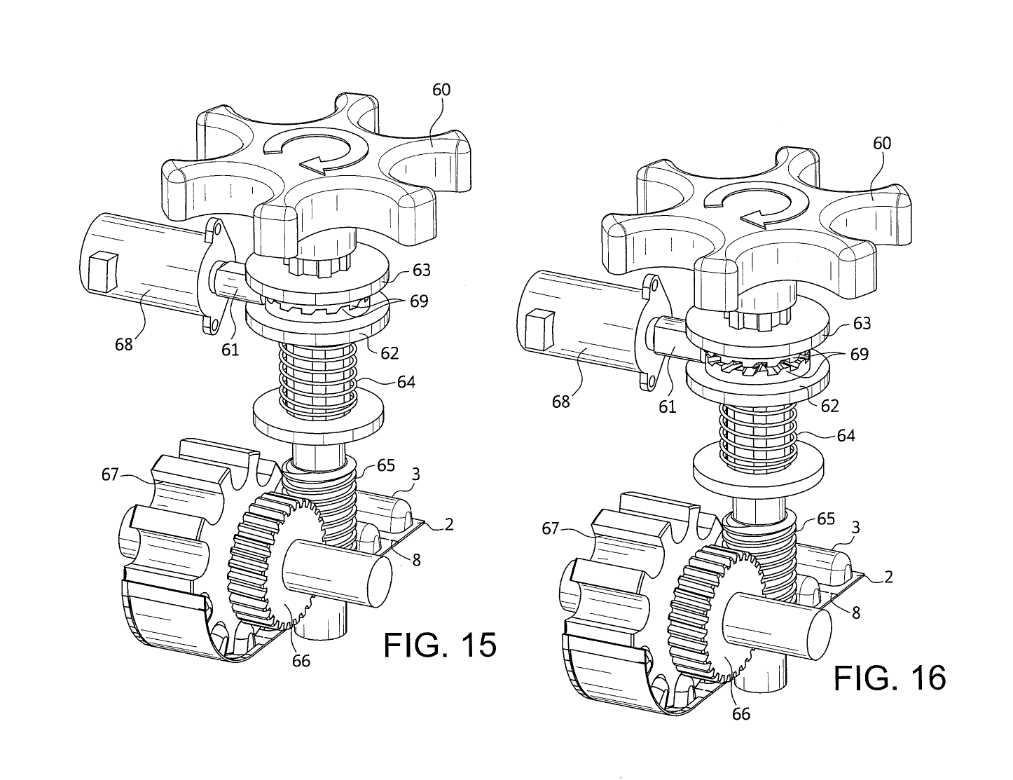

FIGS. 15 and 16 show a variation of the solenoid-controlled mechanism of FIGS. 12-14, in which the sliding manual actuator 35 is replaced by a rotatable knob or handle 60 on the outside of the dispensing device, the cam is in the form of a variable diameter shaft 61, and the ratchet mechanism includes two facing ratchet wheels 62 and 63. When the shaft 61 is rotated by solenoid 68 to a first position, in which the cam surfaces are closer together as shown in FIG. 15, the ratchet wheels 62 and 63 are urged towards each other by a spring 64 to permit engagement of facing ratchet teeth, enabling manually-applied rotational torque on the knob 60 to be transmitted to the advancing mechanism, which includes worm gear 65, drive gear 66, and sprocket wheel 67, thereby advancing the strip 2.

When the solenoid 68 is de-energized, the cam shaft 61 returns to a second position in which the cam surfaces that face the ratchet wheels 62 and 63 are further apart, as shown in FIG. 16, the ratchet wheels 62 and 63 are separated against the spring bias provided by spring 64 to disengage the ratchet teeth 69 and prevent transmission of rotational torque from the knob 60 rotation to the worm gear 65 and sprocket wheel 67. In this position, the worm gear 65 acts as a parking brake to prevent the strip from being forcibly pulled out of the dispensing device. The solenoid 68 may be activated in response to a timer or counter, and the controller may further require verification of authentication information such as biometric data from a fingerprint of eye scan before rotating the solenoid to permit engagement of the ratchet teeth 69 and advancement of the bandolier or strip 2.

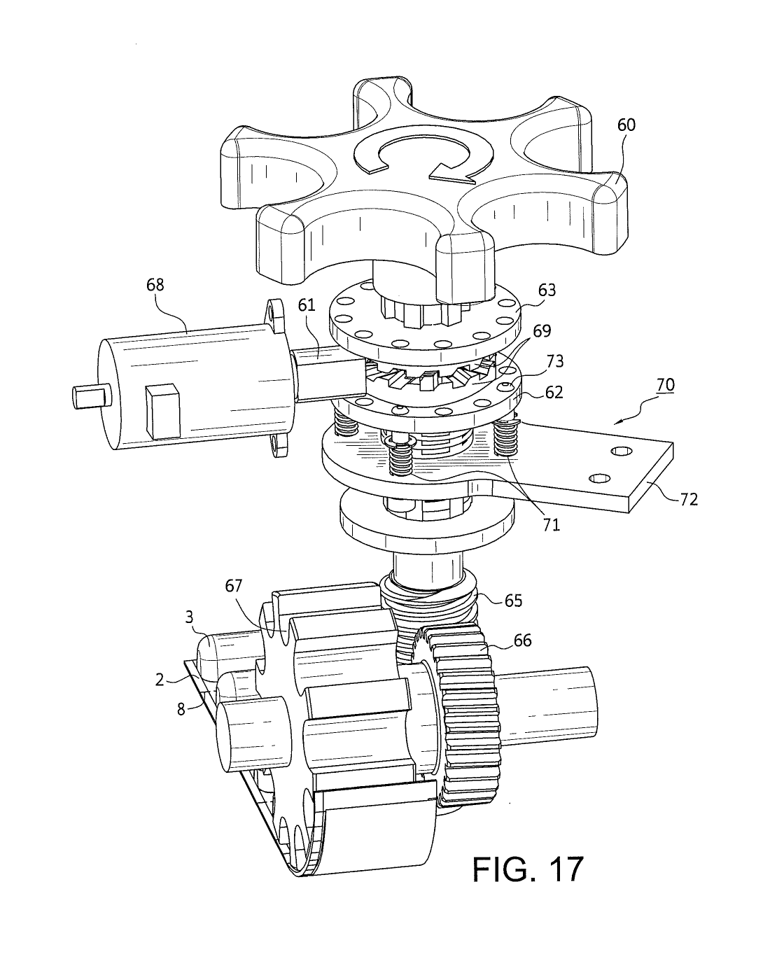

In the variation shown in FIG. 17, the mechanism of FIGS. 15 and 16 is further provided with a spring-loaded locking spring mechanism 70 consisting of spring-loaded locking pins 71 extending from a stationary frame 72. The spring-loaded locking pins 71 engage apertures 73 in the advancing-mechanism-side ratchet gear 62 when the ratchet gears 62 and 63 are in the neutral, separated position to positively prevent turning of the worm gear 65, and thereby provide further protection against attempts to force advancement of the bandolier by pulling on an end of the strip 2 from outside the dispensing device.

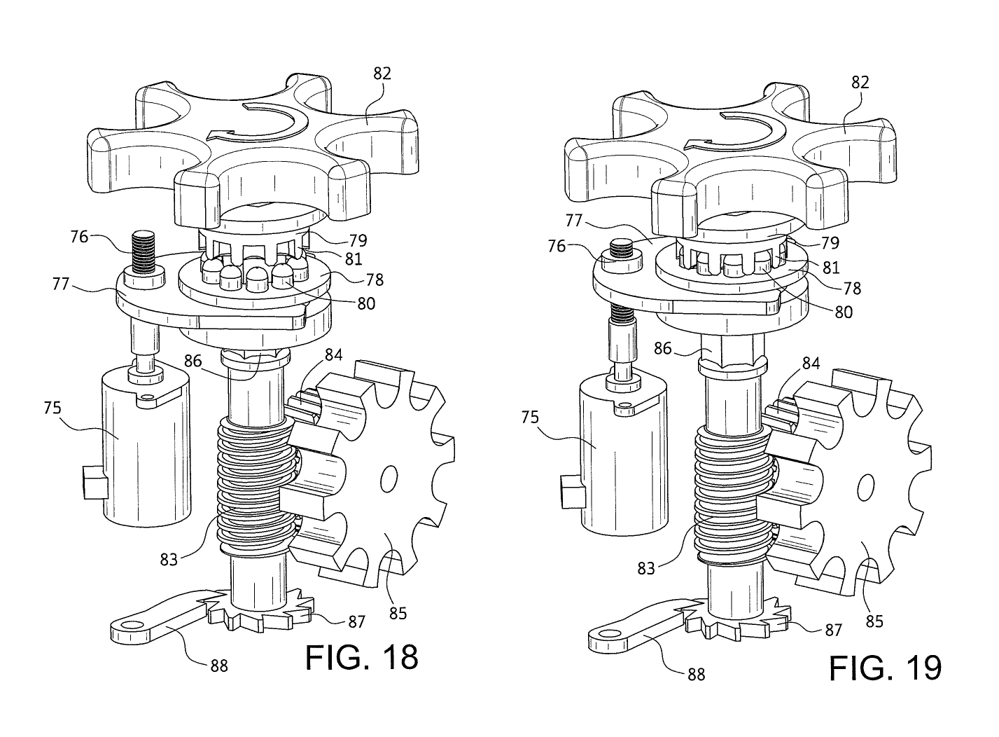

In the variation shown in FIGS. 18 and 19, the solenoid-actuated clutch is replaced by a motor-controlled clutch mechanism that includes a motor 75, threaded shaft 76, thread drive follower plate 77, and facing first and second rotatable clutch plates 78 and 79 having complementary interengaging projections 80 and 81. When the motor 75 is driven to cause the clutch plates 78 and 79 to move towards each other and cause engagement of the respective projections 80 and 81, as shown in FIG. 19, manual torque applied to the rotatable handle or knob 82 is transmitted to the worm gear 83, drive gear 84, and sprocket wheel 85 to advance the strip (not shown). When the motor 75 is driven in reverse to separate the rotatable plates as shown in FIG. 18, transmission of torque from the knob 82 to the sprocket wheel 85 is prevented, thereby preventing advancement of the strip. As illustrated in FIGS. 18 and 19, the rotatable clutch plate that is on the sprocket wheel side of the advancement mechanism may be slidably mounted on a keyed or asymmetric shaft 86 of the worm gear 83.

In this embodiment, one way movement of the strip is achieved by a ratchet wheel 87 and spring-loaded ratchet arm 88 at an end of the worm gear that is opposite the clutch mechanism, although it is also possible to replace the projections 80 and 81 on the clutch plates 78 and 79 with ratchet teeth to achieve a ratchet effect. It will further be appreciated that the illustrated motor and thread drive, as well as the solenoid-operated clutches and stepper motor driven advancement mechanisms described above are all exemplary in nature and may be varied or modified without departing from the scope of the invention.

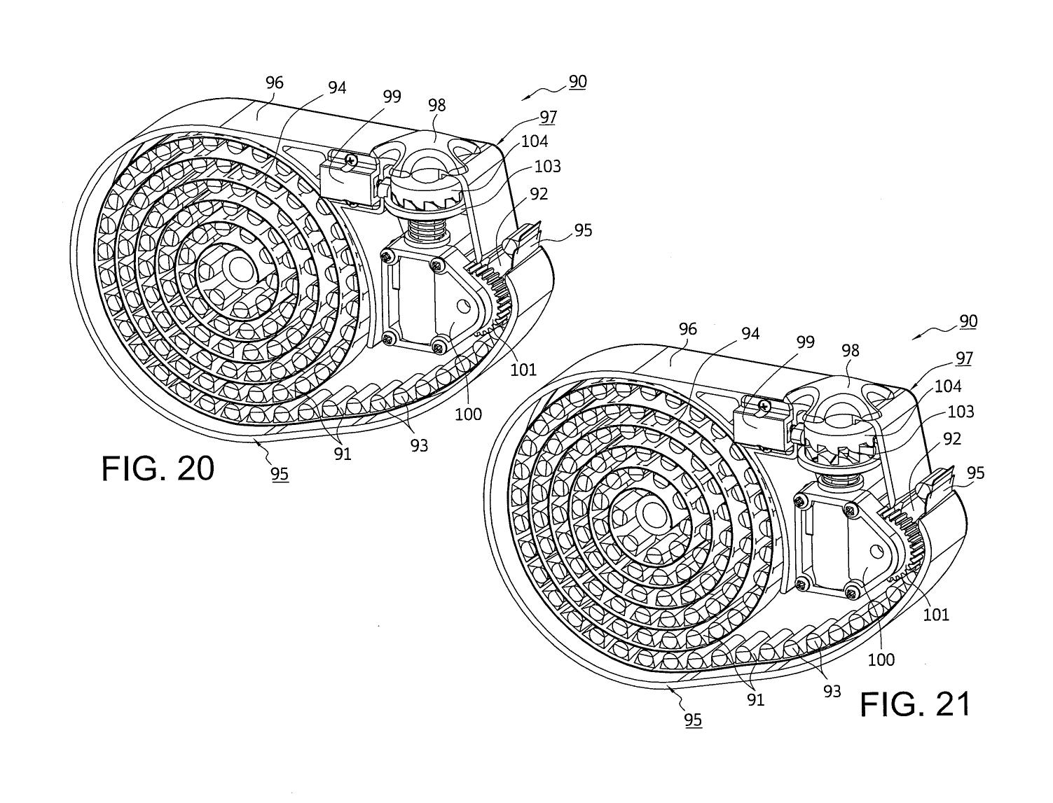

FIGS. 20-23 show an embodiment of the dispensing device 80 that includes the ratchet advancing mechanism of FIGS. 8, 10, and 11, and additional features of the invention that may also be used with the advancing mechanisms of any of FIGS. 6-19. Because this embodiment advances sections of the strip 91 to an opening 92 accessible from outside the dispensing device, rather than using a deblister mechanism to remove individual pills, tablets, or capsule from the bandolier, the strip and blisters, bubbles, or individual pill/tablet containers or holders 93 is wound in a single spiral 94 that permits the end 95 of the strip to exit through the opening 92.

As shown in FIGS. 20 and 21, the housing 95 of the dispensing device 90 includes a main section 96 having a circular compartment or chamber for receiving the spiral-wound portion 94 of the bandolier, the solenoid/ratchet mechanism 97 (which by way of example includes knob 98, solenoid 99, ratchet wheels 103 and 104 worm/advance gear train enclosed by a gear box 100, sprocket wheel 101, and a battery power source (not shown)). The housing 95 also includes a cover 102 that is secured to the main section 96 by tamper-proof locking fasteners 105 and 106 extending through openings in the respective main section 96 and cover 102. The main section 96 and cover 102 may be arranged to overlap the main housing section to provide further resistance to tampering, and the housing 95 should preferably be made of a material sufficient to prevent breakage. Furthermore, sensors or detectors may be provided anywhere in the housing to detect attempts at unauthorized access, including limit switches that record opening of an exit opening access door (not shown) that might be provided to cover the opening through which the strip is advanced or through which deblistered doses are retrieve by any method other than the patient's push button or manual slide/knob action.

As illustrated in FIGS. 20-23, the cover 102 supports an electronic display 110, such as an LCD display, for displaying content type, status, and other information. Buttons 111 and 112 may be provided within the cover 102 so that they are only accessible when the cover is opened to set or reset the radio frequency identification (RFID) tag or tags (not shown), and for setting the number of doses that a patient may have within a unit time, and other settings. The buttons 111 and 112 are preferably deactivated before securing the dispenser.

The dispensing device 90 may further include a biometric scanner, and/or a device such as a voice reader, touchscreen, keypad, or other input device (not shown) for inputting a personal identification number (PIN), password, or code. In addition, the dispensing device 90 may include other sensors, such as an oxygen finger sensor (also not shown) that detects a patient's oxygen levels and that will prevent drugs from being dispensed if the patient's oxygen levels are too low, so as to prevent dispensing of a pill that might overdose the patient. Alternatively, instead of providing the sensor(s), scanner, or other input on the dispensing device itself, cable connectors or wireless transceivers may be provided to connect the dispensing device controller to an external sensor, scanner, or other input device.

The dispensing device 80 may be supplied with an AC power cord and a DC back-up battery back. While energizing the motor, the AC power supply also recharges the battery back-up system. This provides continual service from the machine even when the user has not access to AC power. The back-up system is capable of powering the system for a sufficient amount of time to fulfill the prescription and maintain the integrity of computer data until the dispensing device is returned to the dispensing organization or is otherwise recovered.

The onboard controller or computing device may have a number of functions:
Activating a locking and unlocking function for loading fresh blister-packs and disposal of unused drugs;
Storing a patient's personal identification information;
Allowing tracking through a GPS chip;
Containing RFID coded information that identifies a dispensing device;
Storing information about the dispensing device's history and current use;
Timing a motor activation enabling function or dispensing device shut down;
Providing a passcode or finger print/biometric identification function to control a mechanism that allows access to the patient only;
Displaying programmed information on the display screen.

Computer operations are preferably partitioned so that only specific functions can be carried out by specific designated people through the entire cycle, form packing, to the consumer, to destroying, and back to packing. For example, the only persons that can unlock the housing allowing access to the bandolier or blister-pack will be authorized DEA inspector personnel, or other trusted personnel who have been subject to security/background check procedures at either the packing facility or a disposal facility. No other person can access the pills, tablets, capsules in bulk. Furthermore, the only persons that can access individual portions or doses of the prescription pill are patients, and the only persons that can input prescription information are licensed pharmacists. Each segmented area of functionality/authority creates another firewall against potential abuse and drug dealing.

Once the bandolier or blister pack has been loaded into the dispensing device, the locked dispensing device may be transported to a pharmacy and provided to a patient upon presentation by the patient of a verified prescription for the contents of the dispensing device, or the locked dispensing device may be shipped directly to the patient. If transported to a pharmacy, patient information is entered by the pharmacist through a connection to a computer, a touch screen, or any other data entry means, with the patient being the only person that can access individual portions or does of the pills contained in the dispenser, and pharmacists the only persons that can input patient information, including the dosage and duration of the prescription. When a programmed interval between doses has elapsed, the optional LCD may display the availability of access, at which time the patient can enter a password and either (a) press a button, or input biometric information through a fingerprint sensor or the like, to cause the stepper motor to advance and enable removal of a dose by a deblister wheel or by exposure of a section of the strip at an opening of the dispensing device, or (b) operate a manual slide or knob to advance the strip upon engagement of a solenoid or motor operated clutch, as described above.

When the prescription has expired, whether or not all of the pills have been dispensed, the dispensing device will lock down and a message may be displayed on the optional LCD screen to instruct the patient to return the dispenser to the disposal facility, or the lockdown status otherwise displayed with, for example, instructions printed on the dispensing device advising the patient to return the dispenser when the display is activated. A pre-labeled shipping box may be provided by the pharmacy when the prescription is filled to enable return by mailing or courier, or the dispenser may be directly returned by the patient to the pharmacy or a designated return facility. From the moment of lockdown, no one can access the contents except at the approved disposal facility.

Should the dispensing device fail to be returned within a predetermined number of days, an automated report will be generated by the packing facility to alert the physician, pharmacy, and patient that the dispensing device is missing. GPS tracking may be utilized to find the dispenser and law enforcement contacts as necessary to investigate the failure to return and take appropriate action against the patient or others.

FIG. 24 illustrates a preferred embodiment of a method that utilizes the dispensing device of FIGS. 1-23 to control access to medications as generally described above, according to a preferred embodiment of the invention.

Block 200 indicates the loading of the blister packs into the dispensing device. At this time, identification strips are added or written into to inventory the contents of the dispensing device, and associated with an identifier of the dispensing device itself, such as a serial number. This information is stored in a database, which is part of the system of the preferred embodiment.

Block 210 indicates vaulted storage of the dispensing device until ordered by a pharmacy, and block 220 indicates shipment of the dispensing device to a pharmacy to await transfer to a patient upon presentation of a prescription.

When a prescription and valid patient identification are presented to the pharmacist, as indicated by block 230, the pharmacist enters the number of doses, dosage intervals, prescription expiration date, and any other information relevant to dispensing of the medications into the dispensing device, and associates this information with RFID and serial number read from the dispensing device in a database of the pharmacy. If the dispensing device is provided with a biometric reader, then the pharmacist has the patient enter the biometric information, for example by scanning a fingerprint, to provide biometric lockout. Otherwise, the pharmacist may have the patient input a password or PIN that permits access to the dispensing device and the pre-programmed dose intervals. At this time, the patient is also provide with the terms by which the dispensing device is to be held, which may be referred to as a lease (the lessor being the company that packs the dispensing device and to whom the dispensing device is to be returned following the end of the lease or expiration of the prescription), and optionally asked to sign a lease document, provide insurance information, and/or pay a deposit. The patient then takes the dispensing device home and uses it to dispense medications according to the programmed dosage and schedule.

As indicated by block 240, at the end of the lease or upon expiration of the prescription, the dispensing device turns itself off and can no longer be accessed. The patient then returns the dispensing device to the lessor or an agent thereof for disposal (block 250). The return may be by pre-paid shipping or by hand-delivery to the original pharmacy or a receiving center, which then ships the dispensing device back to the lessor. Any medications still in the dispensing device after return to a secure disposal facility are incinerated, the dispensing device is cleaned, the previous label is removed, and the dispensing device is prepared for reloading in step 200. In addition, the patient, doctor, and pharmacist may be notified of receipt of the dispensing device by the disposal facility, and the amount of the amount doses returned (block 260), at which time any deposit will be credited or returned to the patient or patient's insurance (block 270).

As indicated by block 280, if the patient attempts to tamper with the dispensing device in order to retrieve medications at times other than those permitted by the prescription, then the dispensing will detect the tampering, either by detecting advance of the strip or opening of the dispensing door, or by any other suitable tamper detection means and, as indicated by block 290, alert the medication provider, i.e., the lessor and/or another monitoring organization, company, or agency designated by the lessor or pharmacist. The alerted party then attempts to notify the patient that it has detected tampering, as indicated by block 300 and, depending on the patient's response, either bills the patient for the lease violation or not returning the dispensing device, and notifies the doctor or pharmacist (block 300) and/or law enforcement (block 330) if the patient does not respond or reports the dispensing device lost or stolen. If the dispensing device is provided with GPS or other tracking capabilities, then law enforcement will attempt to track the dispensing device, as indicated by block 340, report the violation in a database (block 350), and, if the dispensing device is recovered, return it to the lessor (block 360).

It is also possible that the patient might report the dispensing device as lost or stolen before tampering occurs and/or is detected (block 370). In that case, the patient's deposit is forfeited (block 380) and law enforcement notified (block 390). Law enforcement then attempts to track the dispensing device and, if located, returns the device to the lessor for content disposal (step 400).

Finally, it may be that evidence of tampering is found after return of the dispensing device to the disposal facility (block 250), as indicated by block 410. In that case, the patient or patient's insurance is billed for any damage to the dispensing device (block 420), the patient, doctor, and pharmacist are notified (block 260), and law enforcement notified (block 430).

The steps listed above are exemplary and may be varied without departing from the scope of the invention. For example, as an alternative to distribution of the dispensing device through independent pharmacies, the secure facility may have its own pharmacists and ship the pre-loaded class 2 drugs directly to the patient with the correct dose already programmed into the locked device.

1. A dispensing device for dispensing controlled numbers of individual medication doses or other items at predetermined minimum intervals, comprising:
a casing including a compartment for installing one of a cartridge or bandolier, the cartridge or bandolier including a strip and a plurality of individual doses or items, wherein the cartridge or bandolier is locked in the casing;
a strip advancing mechanism for advancing the strip to present one said individual dose or a predetermined number of said individual items for access by a patient; and
a controller for preventing advancement of the strip unless predetermined criteria are met.

2. A dispensing device as claimed in claim 1, wherein the individual doses or items are installed in blister packages on the strip, and said dispensing device includes a deblister mechanism arranged to remove a dose or item from a respective package when it is advanced to a dispensing position by the advancing mechanism.

3. A dispensing device as claimed in claim 2, further comprising a non-linear passage between the strip dispensing position and a dispensing opening in the casing through which a dose or item that has been removed from the package travels before exiting the dispensing device, and that does not provide access to the strip from outside the dispensing device.

4. A dispensing device as claimed in claim 2, wherein the deblister mechanism is a wheel having a plurality of arms, said wheel being positioned above the deblister mechanism to rotate upon advancement of the strip such that one of said arms engages and penetrates a respective blister to push a single dose or a predetermined number of items through the strip and into a passage leading to an exterior of the dispensing device.

5. A dispensing device as claimed in claim 2, wherein the strip includes a perforations extending across the strip between individual blisters, said perforations enabling a section of the strip containing at least one blister to be torn away from the strip by a user upon advancement of the strip through an opening in the dispensing device.

6. A dispensing device as claimed in claim 1, wherein the strip is positioned in a sealed cartridge having two spools, a sprocket wheel positioned between the two spools, and a deblister wheel positioned between the two spools, wherein the sprocket and deblister wheels are coupled to a stepper motor upon installation of the cartridge in the dispensing device, the strip advances from one spool to the other upon rotation of the sprocket wheel by the stepper motor, and the doses or items are removed from the strip by the deblister wheel, which rotates with the sprocket wheel.

7. A dispensing device as claimed in claim 1, wherein the advancing mechanism includes a stepper motor connected to a sprocket wheel having sprockets that engage perforations, indentations, or detents extending longitudinally along the strip or that engage individual blisters to advance the strip upon rotation of the wheel by the stepper motor.

8. A dispensing device as claimed in claim 7, wherein an end of the strip containing an individual dose or predetermined number of items is advanced through an exit opening to a position outside the dispensing device upon rotation of the stepper motor so that the end of the strip can be torn off by a user.

9. A dispensing device as claimed in claim 8, wherein the motor is connected to the sprocket wheel by a gear train that includes a worm gear, the worm gear acting as a brake to prevent a user from manually advancing the strip by pulling on the end of the strip that extends out of the opening.

10. A dispensing device as claimed in claim 7, further comprising a sensor for sensing movement of the strip, said sensor outputting a movement detection signal to the controller to enable advancement of the strip by a predetermined amount.

11. A dispensing device as claimed in claim 7, wherein the sprockets wrap around individual blisters to access through the exit opening to individual blisters that have not yet been advanced out of the dispensing device.

12. A dispensing device as claimed in claim 7, wherein the advancement mechanism is manually actuated, and further comprising a solenoid-activated clutch mechanism for preventing movement of the advancement mechanism in response to attempted manual actuation.

13. A dispensing device as claimed in claim 12, wherein the advancement mechanism includes a manually actuated slide connected to a pawl that engages a ratchet wheel upon movement of the slide to cause the ratchet wheel to rotate through a predetermined angle, the ratchet wheel being coupled to a sprocket wheel to advance the strip upon rotation of the sprocket wheel in response to rotation of the ratchet wheel, wherein the solenoid-activated clutch mechanism selectively enables and prevents advancement of the strip by permitting and preventing transmission of manual slide movement through the pawl and ratchet wheel to the sprocket wheel.

14. A dispensing device as claimed in claim 13, wherein the solenoid-activated clutch mechanism includes including a solenoid and a cam for selectively displacing the pawl towards and away from the ratchet wheel.

15. A dispensing device as claimed in claim 13, wherein the ratchet wheel is connected to the sprocket wheel by a gear train that includes a worm gear, the worm gear acting as a brake to prevent a user from manually advancing the strip by pulling on the end of the strip that extends out of the opening.

16. A dispensing device as claimed in claim 12, wherein the advancement mechanism includes a knob connected to a first ratchet wheel, a second ratchet wheel engageable with the first ratchet wheel and connected to a sprocket wheel for advancing the strip, and a spring for biasing one of the ratchet wheels into engagement with the other of the ratchet wheels, and wherein the solenoid-actuated clutch mechanism includes a solenoid and a cam spacer extending between the ratchet wheels to prevent engagement of the ratchet wheels unless the cam is energized to rotate the cam spacer to a position that enables the second ratchet wheel to engage the first ratchet wheel and thereby transmit rotational movement of the knob to the sprocket wheel.

17. A dispensing device as claimed in claim 16, wherein the second ratchet wheel is connected to the sprocket wheel by a gear train that includes a worm gear, the worm gear acting as a brake to prevent a user from manually advancing the strip by pulling on the end of the strip that extends out of the opening.

18. A dispensing device as claimed in claim 17, further comprising at least one spring-loaded locking pin extending from a stationary frame for preventing rotation of the second ratchet wheel when it is disengaged from the first ratchet wheel to prevent the strip from being manually pulled out of the dispensing device.

19. A dispensing device as claimed in claim 1, wherein the advancement mechanism includes a manual actuator connected to a sprocket wheel for engaging and advancing the strip upon rotation of the manual actuator, the manual actuator being connected to the sprocket wheel via a motor driven clutch mechanism having an engaged position in which advancement of the strip is enabled and a disengaged position in which advancement of the strip is disabled.

20. A dispensing device as claimed in claim 19, wherein the clutch mechanism includes a first rotatable clutch plate connected to the manual actuator, a second rotatable clutch plate connected to the sprocket wheel, and a screw drive for causing the first and second rotatable clutch plates to move towards and away from each other between said engaged position and said disengaged position.

21. A dispensing device as claimed in claim 20, wherein said first and second rotatable clutch plates each includes axially extending projections that interengage when the rotatable clutch plates are in the engaged position.

22. A dispensing device as claimed in claim 20, wherein said manual actuator is a rotatable knob.

23. A dispensing device as claimed in claim 20, wherein said second rotatable clutch plate is connected to the sprocket drive by a worm gear having a keyed shaft on which said second rotatable clutch plate is slidably mounted, and a drive gear connected to the sprocket wheel and coupled to the worm gear.

24. A dispensing device as claimed in claim 23, wherein said keyed shaft also supports a ratchet wheel arranged to engage a ratchet pawl to limit manually-actuated rotation of the shaft to one direction.

25. A dispensing device as claimed in claim 1, wherein the dispensing device further includes a cover arranged to be locked to the casing to prevent access to an interior of the casing outside of a secure facility.

26. A dispensing device as claimed in claim 25, wherein the cover is locked to the casing by front and back mating locks.

27. A dispensing device as claimed in claim 25, wherein the cover overlaps the casing to prevent tampering.

28. A dispensing device as claimed in claim 25, wherein the cover includes an electronic display for displaying information related to contents and use of the dispensing device, said information including an indication of when a dose may be dispensed.

29. A dispensing device as claimed in claim 25, wherein a first button and at least two second buttons are provided inside the cover so as to be inaccessible when the cover is locked to the casing, the first button resetting a radio frequency identification (RFID) tag within the dispensing device and the second buttons enabling input of dosage information to the controller.

30. A dispensing device as claimed in claim 1, wherein the dispensing device further includes an input device for inputting user authentication information to verify the identity of a user before enabling a dose or item to be dispensed.

31. A dispensing device as claimed in claim 30, wherein the user authentication information includes biometric information, and the input device includes a biometric scanner.

32. A dispensing device as claimed in claim 1, wherein the dispensing device further includes a connection to a finger oxygen sensor for sensing user oxygen levels, said controller preventing dispensing of a dose if the user oxygen levels indicate risk of overdose.

33. A dispensing device as claimed in claim 1, wherein the strip includes containers having separable halves that enable manual filling of pills, tablets, or other items.

34. A dispensing device as claimed in claim 1, wherein the plurality of individual doses or items are prescription drugs listed by the U.S. Drug Enforcement Administration as Schedule 2 controlled substances.

35. A dispensing device as claimed in claim 1, further comprising a tracking device for remotely determining a location of the dispensing device.

36. A method of controlling dispensing of medications or other items to an authorized user according to a predetermined schedule, comprising the steps of:
providing a tamperproof dispensing device having a computer-controlled single-dose or item dispensing mechanism arranged to advance a bandolier and deliver a predetermined dose or item to a user at predetermined intervals;
at a secure packing facility, loading a bandolier containing a plurality of single doses of said medications or a plurality of said other items into the tamperproof dispensing device, and storing identification information concerning the single doses or items loaded into the device with the bandolier;
locking the device to prevent access to the doses or items loaded into the device;
supplying the dispensing device to a patient;
according to said predetermined schedule, a controller in the dispensing device enabling a user to activate the single-dose or item dispensing mechanism and dispense a single dose or item;
after dispensing of the single dose or item, preventing further activation of the single-dose dispensing mechanism until a predetermined interval determined by said schedule has elapsed and, after the another said predetermined interval has elapsed, again enabling activation of the single-dose dispensing mechanism to dispense another said single-dose; and
enabling the device to be unlocked only after all said doses or items in said dispensing device have been dispensed, or after a predetermined period has elapsed.

37. A method of controlling dispensing of medications or other items as claimed in claim 36, wherein said medications or other items are medications.

38. A method of controlling dispensing of medications or other items as claimed in claim 37, wherein said medications are drugs with potential for abuse.

39. A method of controlling dispensing of medications or other items as claimed in claim 36, further comprising the step of, before enabling activation of the single-dose dispensing mechanism, verifying an identity of the patient by requiring input of a password, PIN, or biometric information.

40. A method of controlling dispensing of medications or other items as claimed in claim 36, further comprising the step of, before enabling activation of the single-dose dispensing mechanism, sensing a blood oxygen level of the user and preventing activation of the single-dose dispensing mechanism if the blood oxygen level indicates risk of an overdose.

41. A method of controlling dispensing of medications or other items as claimed in claim 36, wherein the single dose or item is dispensed by the controller controlling a stepper motor to advance the bandolier.

42. A method of controlling dispensing of medications or other items as claimed in claim 36, wherein the step of the controller enabling activation of the single-dose dispensing mechanism comprises the step of the controller energizing a solenoid to actuate a clutch device that connects a manual ratchet mechanism with a sprocket wheel that advances the bandolier, the user then manipulating the manual ratchet mechanism to dispense the single-dose or item.

43. A method of controlling dispensing of medications or other items as claimed in claim 36, wherein the step of supplying the dispensing device to a user comprises the step of first supplying the dispensing device to a pharmacy, the pharmacy supplying the dispensing device to the user upon presentation of a valid prescription, the pharmacy inputting prescription and user identification information into the dispensing device.

44. A method of controlling dispensing of medications or other items as claimed in claim 36, wherein the step of supplying the dispensing device to a user comprises the step of shipping the dispensing device directly from the secure facility to the user.

45. A method of controlling dispensing of medications or other items as claimed in claim 36, further comprising the step of, before supplying the dispensing device to the user, collecting a deposit and causing the user to execute a dispensing device lease agreement.

46. A method of controlling dispensing of medications or other items as claimed in claim 36, further comprising the step of, if the dispensing device is not returned within a predetermined time, if the dispensing device is reported as lost or stolen, or if tampering is detected, notifying at least one of the user, a doctor, a pharmacist, and law enforcement.

47. A method of controlling dispensing of medications or other items as claimed in claim 46, after non-return of the dispensing device, further comprising the step of determining a location of the dispensing device by a tracking device included in the dispensing device.

48. A method of controlling dispensing of medications or other items as claimed in claim 46, further comprising the step of, if the dispensing device is returned or recovered with evidence of tampering, billing the user or user's insurance for damage.

49. A method of controlling dispensing of medications or other items as claimed in claim 36, further comprising the step of, upon timely return of the dispensing device to a disposal facility, disposing of any unused doses in the dispensing device and putting the dispensing device back in service.

50. A method of controlling dispensing of medications or other items as claimed in claim 36, further comprising the steps of, after all said doses or items in said dispensing device have been dispensed, or after a predetermined period has elapsed, continuing to prevent access to the medications or other items by preventing further activation of the single-dose mechanism and unlocking of the dispensing device until the dispensing device has been returned to a disposal facility.
